(19) United States
(12) Patent Application Publication
(10) Pub. No.: US 2013/0286364 A1
(43) Pub. Date: Oct. 31, 2013

(54) Multimedia player and projector

(71) Applicants: Tze-Yun Sung, Taipei (TW); Chih-Wei Chiu, Taipei (TW)

(72) Inventors: Tze-Yun Sung, Taipei (TW); Chih-Wei Chiu, Taipei (TW)

(73) Assignee: Ko, Chi-Yuan of Cordic Technology Co. Ltd.

(21) Appl. No.: 13/455,141

(22) Filed: Apr. 25, 2012

(51) Int. Cl. G03B 21/14

(52) U.S. Cl. 353/119

(57) ABSTRACT

This multimedia player and projector includes a projector and a support on the top of it, and a cover could be lift and turn backward to open, which is assembled on one side of the top of the projector. There is a plug inside the cover which could provide electrical connection between projector and mobile device. Support is for disposing a mobile device which is assembled by a plate which is connected to projector by an axle, and a latch which is assembled on the rare of the plate which could set the angle between the latch and projector from 0 to 90 degrees.

### BACKGROUND OF INVENTION

1. Field of the Invention

The present invention relates to a projector with a plug which could make a connection with mobile device such as notebook by signal transmitting cable.

2. In the Prior Art

In these years, there are many kinds of projectors have been used in the field of video service such as brief [symbol] conference [symbol] speech [symbol] distance learning and home cinema for enlarging the size of image of playing video and showing it on the silver screen or wall.

Present structure of projecting system is shown in FIG. 1. Present projecting system (A) mainly includes mobile device (B) [symbol] projector (A1) [symbol] signal transmitting cable (A3) [symbol] power supply (A4) and power cord (A5). In FIG. 1, it shows The power supply (A4) is connected to mobile device (B) and plug in the outlet for providing electricity to mobile device, and power cord (A5) is connected to the projector (A1) and plug in the outlet for providing electricity to projector. Mobile device (B) is connected to the projector (A1) by signal transmitting cable (A3) and transmit video signal to projector (A1). Then projector (A1) enlarge the size of image of video with it's own video processing and projecting capability and project the image of video on the screen (A2).

As FIG. 1 shows, to output image of any portable device with present projector, there is no other choice except connect to PC or Notebook with signal transmitting cable, and the file of image in any portable devices should be transferred to PC or Notebook which is for playing with projector. It caused inconvenience of moving of the player due to the volume and weight of present computer, and restrict the type of media player which could use with the projector.

### SUMMARY OF INVENTION

The purpose of this invention is to provide connection between projector and mobile device besides PC or Notebooks, and easy to use.

Because there is no plug or port for the mobile devices except PC and Note book on present projector, The way of improvement is to increase a utility to make connection between mobile device besides PC and Notebook. The invention provides a plug for the connection between projector and mobile device, and a support which is disposed on the top of the projector. The angle between the support and the projector is adjustable so user could choose best angle for operating the mobile device which is connected to the projector. Moreover, there is a rechargeable battery set which is installed inside the projector so the projector is operational even if there is no power supply resources. There is also a outlet on the projector for receiving power with power supply to operate and recharge the battery by main power supply.

### BRIEF DESCRIPTION OF THE DRAWINGS

FIG. 1 is a scheme of embodiment of present projecting system.

FIG. 2 [symbol] FIG. 3 are the illusion of depth of the first exploit example.

FIG. 4 is a scheme of disassembly of the first exploit example.

FIG. 5 is a scheme of practice which mobile device connect with the first exploit example.

FIG. 6 is a scheme of action for the first exploit example.

FIG. 7 is a scheme of the first exploit example operates with main power supply

FIG. 8 [symbol] FIG. 9 are the illusion of depth of the second exploit example.

FIG. 10 is a scheme of disassembly of the second exploit example.

FIG. 11 is a scheme of practice which mobile device connect with the second exploit example.

FIG. 12 is a scheme of action for the second exploit example.

FIG. 13 is a scheme of the second exploit example operates with main power supply.

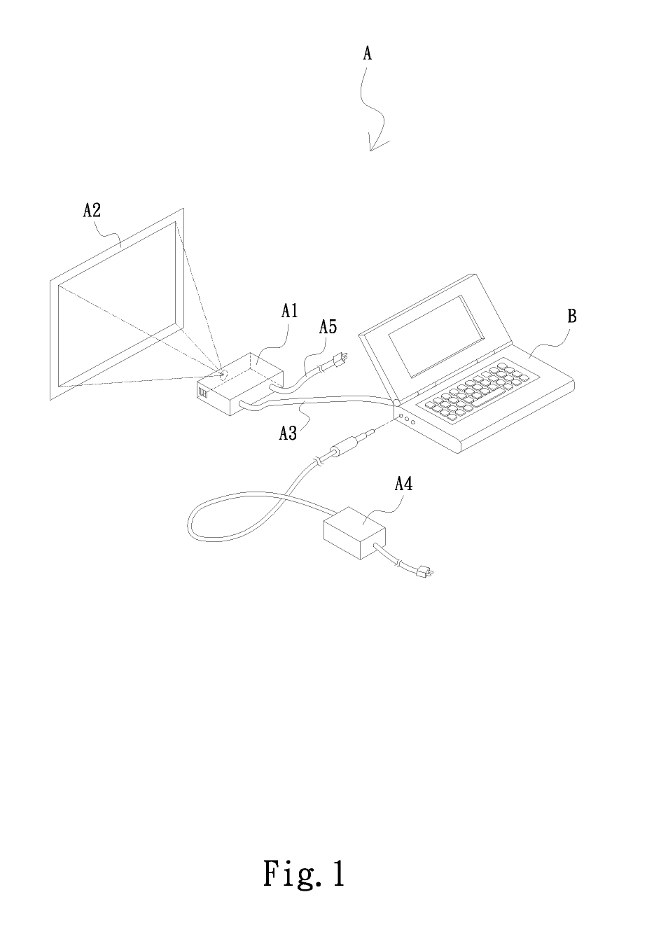

### DETAILED DESCRIPTION OF PREFERRED EMBODIMENTS

### A First Varent Embodiment

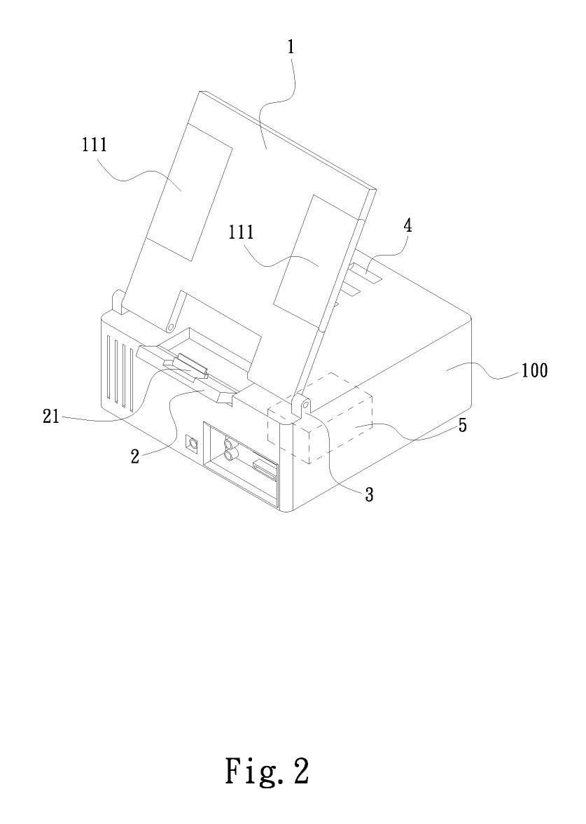

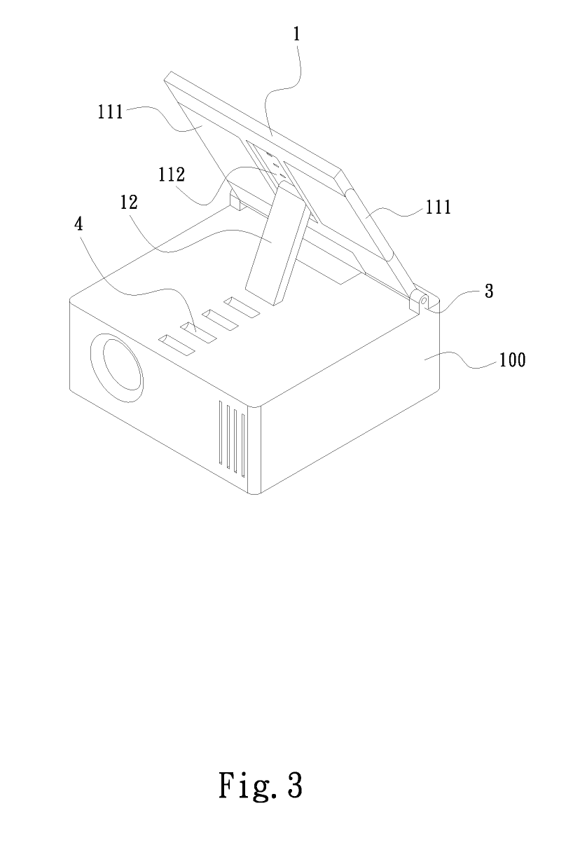

The schemes about first embodiment is from FIG. 2 to FIG. 7

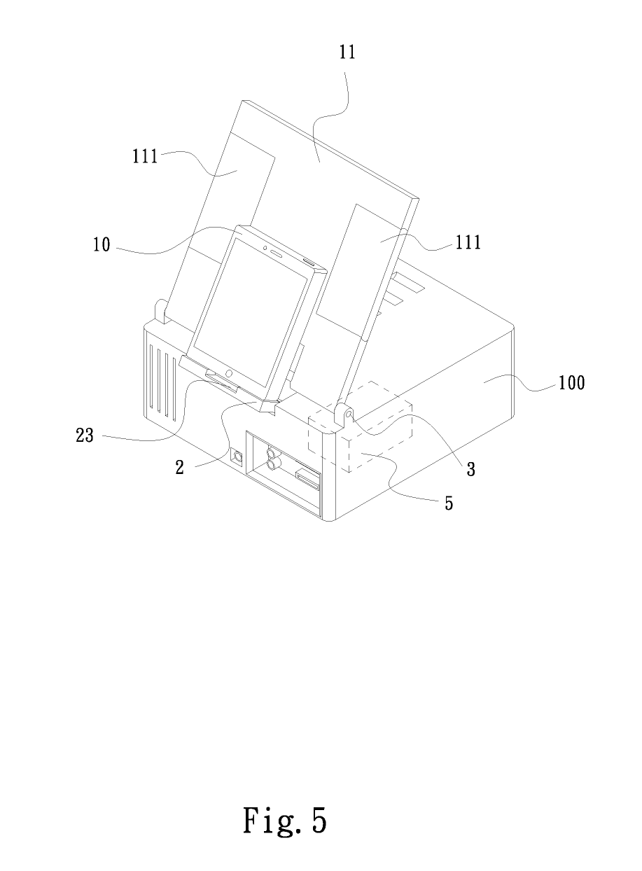

In FIG. 2, the said multimedia player and projector includes:
a projector (100);
a support (1) which is for disposing the mobile device (10) (see FIG. 5), and the support (1) is assembled on a side of the top of the projector (100);
a cover (2) which is assembled on a side of the top of projector (100), and the cover (2) could be opened and closed by lift up and down.

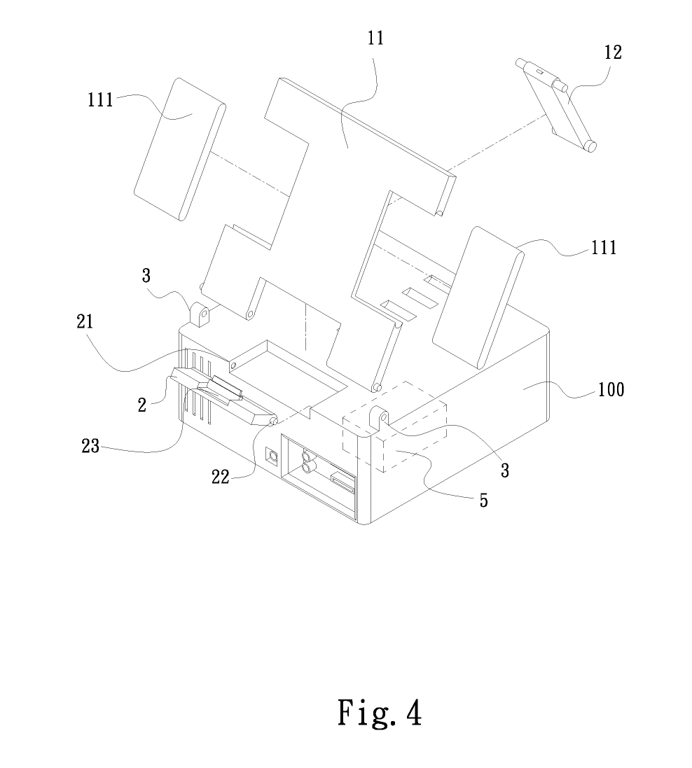

In FIG. 4, the said support (1) is assembled by a plate (11) which is connected to projector (100) by 2 axle blocks (3) and a latch (12) which is assembled on the rare of the plate (11) which could set the angle between the latch (12) and projector (100) from 0 to 90 degree. There is a plug (21) and a container (23) for restoring the plug (21) inside the said cover (2) which could provide electrical connection between projector and mobile device (10) (see FIG. 5).

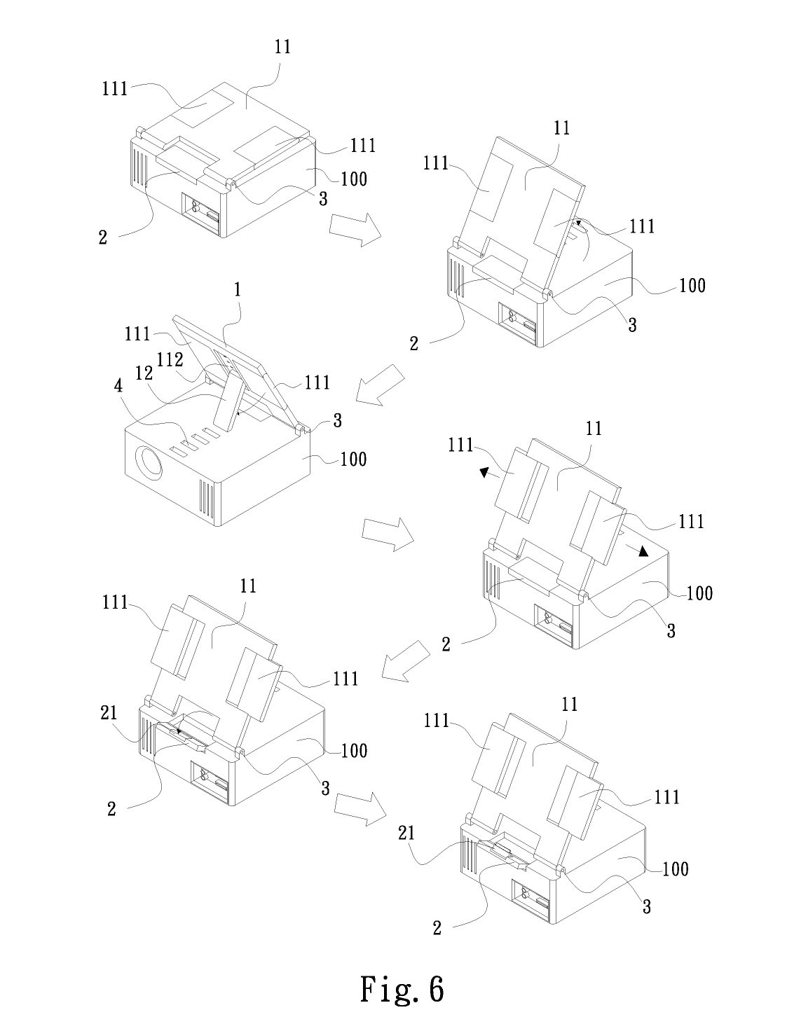

In FIG. 4 [symbol] FIG. 6, according to the multimedia player and projector said above, there are 2 axle blocks (3) which are disposed on both end point of sides of the top of projector (100), and there are several slots (4) on the top of projector (100) which is for fixing the position of the latch (12). The said project (100) is one of following utility: projector, micro projector. The plate (11) which is assembled with projector (100) has 2 boards (111) which are on the left and right side of the plate (11), and they could slide outward horizontally to adjust the width of the plate (11) for adapt the size of mobile device (10) which is disposed on the support (1). The rare side of the plate (11) has a gutter (112) for restoring the latch (12). There is a bottom stick (121) (see FIG. 9) on the bottom of the latch (12) which fix the slots (4) on the top of projector (100). There are axle connectors (22) on both side of the tail of said cover (2) which is assembled with projector (100) by it.

Moreover, there is a rechargeable battery set (5) which is installed inside the said projector (100) so the projector could operate without main power supply which could connect to the main power supply for recharging.

In FIG. 5, according to the Projector said above, the said mobile device (10) is one of following: smartphone, tablet PC, personal digital assistant, electronic book reader, digital camera and multimedia player.

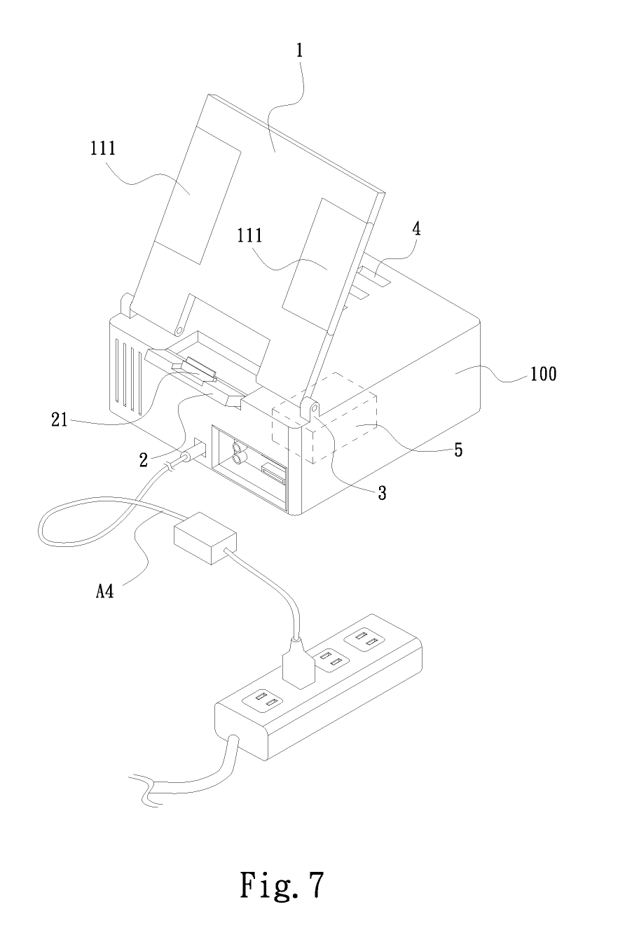

FIG. 7 shows the said Projector is powered by the main power supply.

User could dispose the mobile devices (10) on the support (1) which the angle between support (1) and projector (100) is adjustable from 0 to 90 degrees for adjusting proper position of the mobile device (10) for inputting messages, and transmit the massage which user want to express through the plug (21) to the projector (100) and project the message on the silver screen or wall for achieving two way communication.

### A Second Varent Embodiment

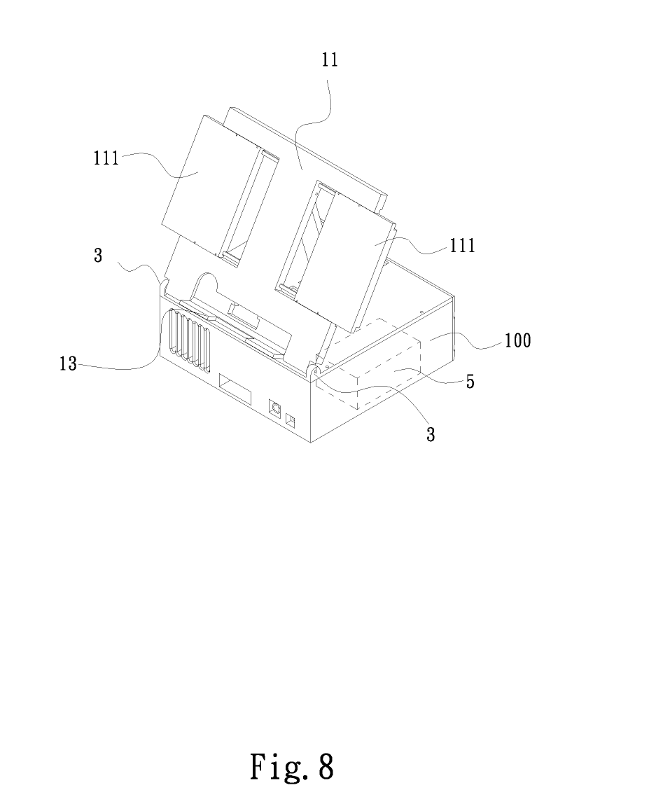

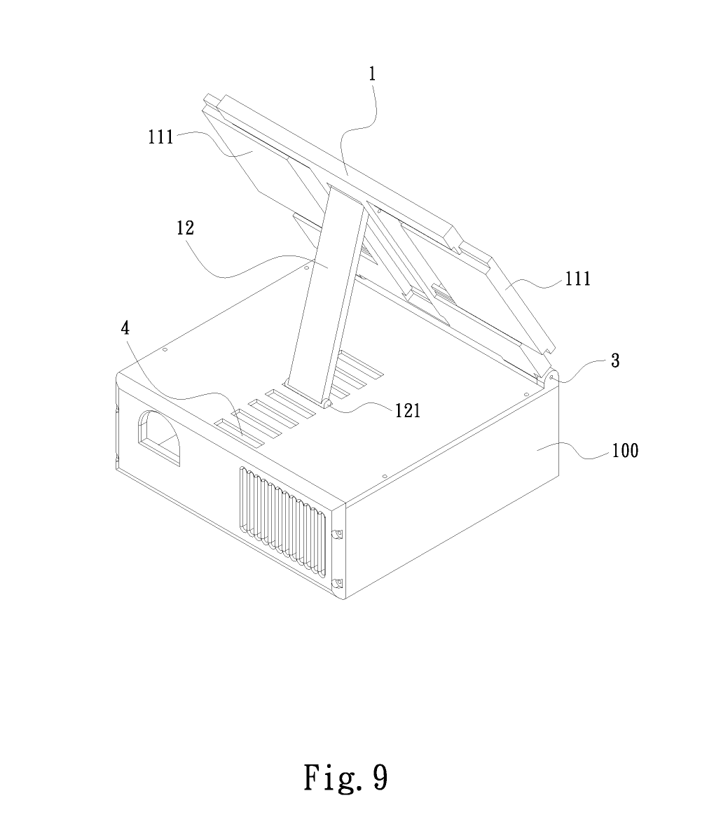

The schemes about first exploit example is from FIG. 8 to FIG. 13.

In FIG. 8, the said multimedia player and projector includes:
A projector (100);
A support (1) which is for disposing the mobile device (10), and the support (1) is assembled on a side of the top of the projector (100). The said support (1) is assembled by a plate (11) which is connected to projector (100) by 2 axle blocks (3) and a latch (12) which is assembled on the rare of the plate (11) which could set the angle between the latch (12) and projector (100) from 0 to 90 degree;
A base (13) which is on the bottom of the plate (11) for sustaining the mobile device which is disposed on said projector (100);

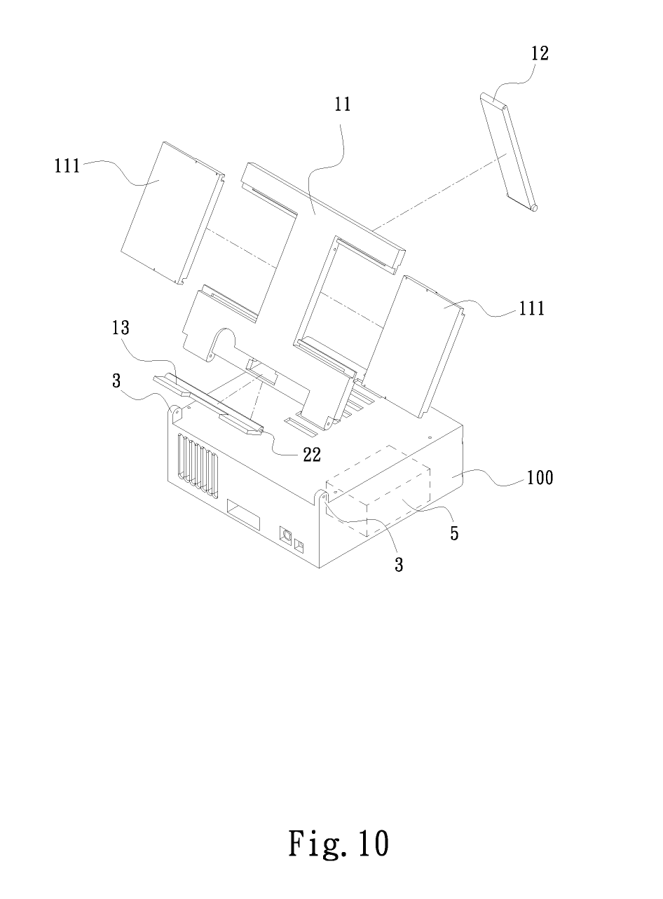

In FIG. 10, the said support (1) is assembled by a plate (11) which is connected to projector (100) by 2 axle blocks (3) and a latch (12) which is assembled on the rare of the plate (11) which could set the angle between the latch (12) and projector (100) from 0 to 90 degree. There is a base (13) which is on the bottom of the plate (11) for sustaining the mobile device which is disposed on said projector (100). There are axle connectors (22) on both side of the tail of said base (2) which is assembled with projector (100) by it.

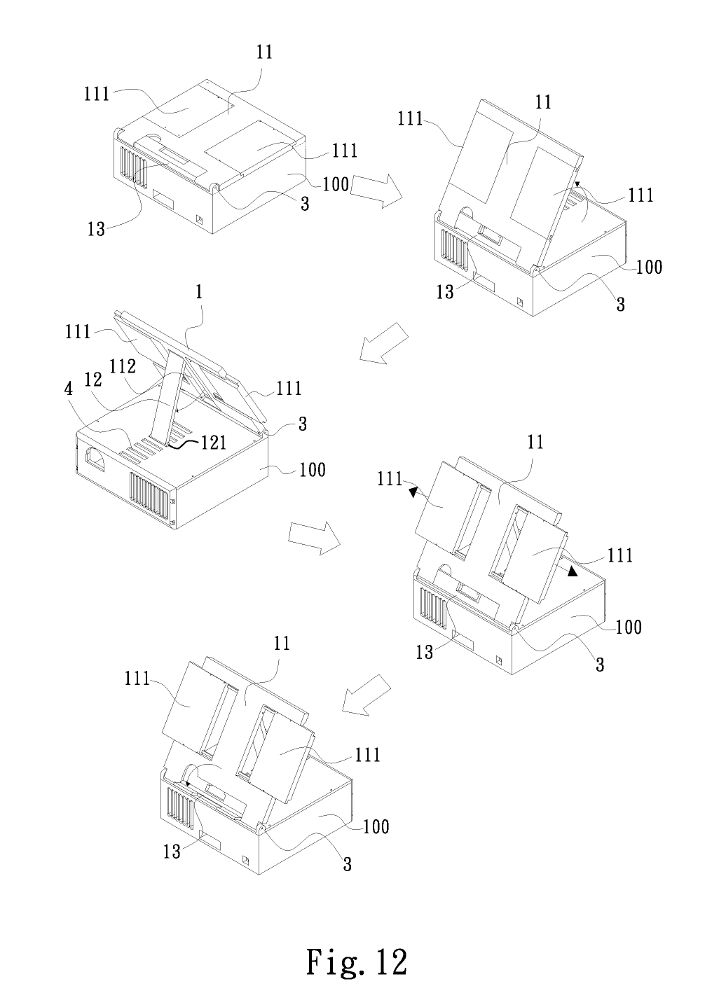

In FIG. 10 [symbol] FIG. 12, according to the Projector said above, there are 2 axle blocks (3) which are disposed on both end points of sides of the top of projector (100),and there are several slots (4) on the top of projector (100) which is for fixing the position of the latch (12). The said project (100) is one of following utility: projector, micro projector. The plate (11) which is assembled with projector (100) has 2 boards (111) which are on the left and right side of the plate (11), and they could slide toward outside to adjust the width of the plate (11) for adapt the size of mobile device (10) which is disposed on the support (1). The rare side of the plate (11) has a gutter (112) for restoring the latch (12). There is a bottom stick (121) (see FIG. 9) on the bottom of the latch (12) which fix the slots (4) on the top of projector (100). There are axle connectors (22) on both side of the tail of said base (13) which is assembled with projector (100) by it.

Moreover, there is a rechargeable battery set (5) which is installed inside the said projector (100) so the projector could operate without main power supply which could connect to the main power supply for recharging.

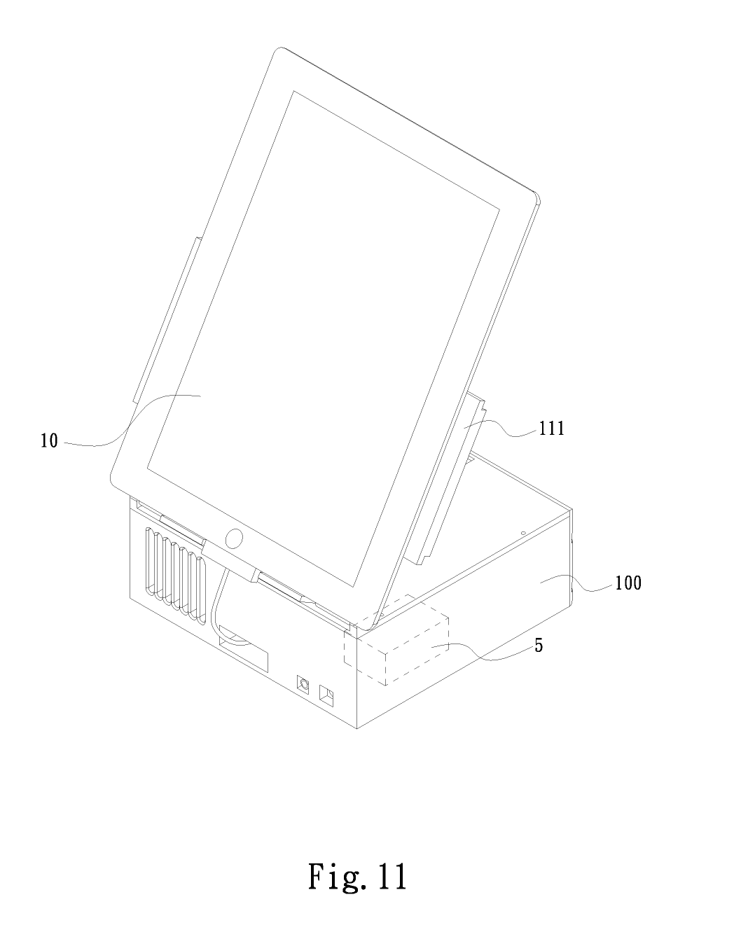

In FIG. 11, according to the Projector said above, the said mobile device (10) is one of following: smartphone, tablet PC, personal digital assistant, electronic book reader, digital camera and multimedia player. The cable which is attached on the rear panel is responsible for the connection between the mobile device (10) and said projector (100).

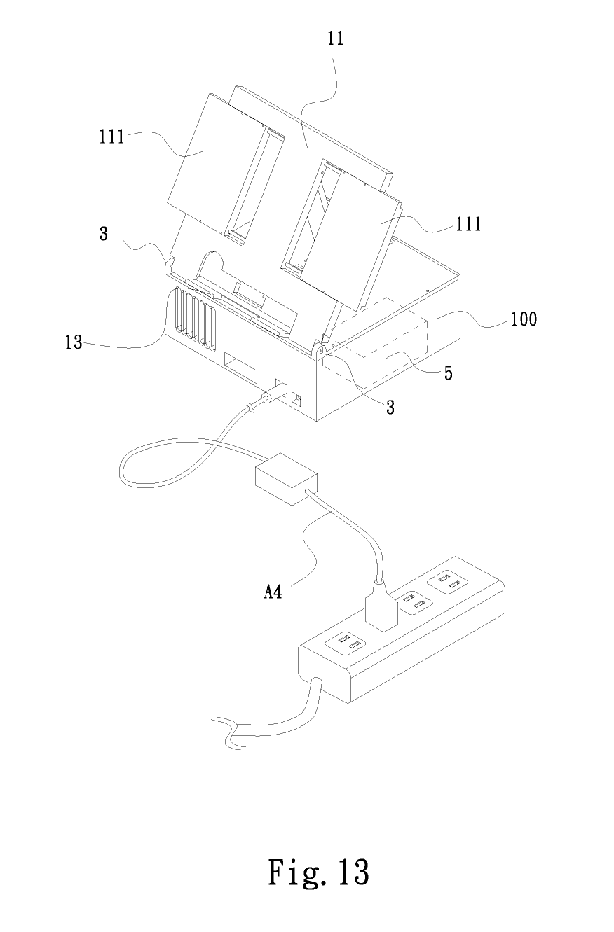

FIG. 13 shows the said projector is powered by the main power supply.

User could dispose the mobile devices (10) on the support (1) which the angle between support (1) and projector (100) is adjustable from 0 to 90 degrees for adjusting proper position of the mobile device (10) for inputting messages, and transmit the massage which user want to express through The cable which is attached on the rear panel of projector (100) and project the message on the silver screen or wall for achieving two way communication.

According above, These 2 embodiments provide a new way of connecting with variant mobile devices and increase the information resources which could be viewed by projecting. They also become more portable and flexible for the place and environment of using because of the rechargeable battery set (5) which is installed in the projector (100).

What is claimed is:

1. A multimedia player and projector, comprising:
a projector (100); a support (1) which is assembled on a side of the top of the projector (100) is for disposing the mobile device (10); a cover (2) which is assembled on a side of the top of projector (100), and the cover (2) could be opened and closed by lift up and down; the said support (1) is assembled by a plate (11) which is connected to projector (100) by 2 axle blocks (3) and a latch (12) which is assembled on the rare of the plate (11) which could set the angle between latch (12) and projector (100) from 0 to 90 degrees; there is a plug (21) inside the said cover (2) which could provide electrical connection between projector (100) and mobile device (10) or and There is a cable which is attached on the rear panel of said projector (100) for connect the mobile device (10) to said projector (100).

2. A multimedia player and projector according to claim 1 wherein the said projector (100) has 2 axle blocks (3) which are disposed on both end of sides of the top of said projector (100), and there are several slots (4) on the top of said projector (100) which is for fixing the position of the latch (12).

3. A multimedia player and projector according to claim 1 wherein the said projector (100) is one of following utility: projector, micro projector.

4. A multimedia player and projector according to claim 1 wherein the said plate has 2 boards (111) which are on the left and right side of the plate (11), and they could slide outward horizontally to adjust the width of the plate (11) for adapt the size of mobile device (10) which is disposed on the support (1). The rare side of said plate (11) has a gutter (112) for restoring the latch (12).

5. A multimedia player and projector according to claim 1 wherein the said latch (12) has bottom stick (121) on the bottom of the latch (12) which could stuck into the slots (4) on the top of projector (100) (see FIG. 9).

6. A multimedia player and projector according to claim 1 wherein the said mobile device (10) is one of following: smartphone, tablet PC, personal digital assistant, electronic book reader, digital camera and multimedia player.

7. A multimedia player and projector according to claim 1 wherein the said cover (2) has axle connectors (22) on both side of the tail of said cover (2) which is assembled with projector (100) by it, and there is a plug (21) and a container (23) for restoring the plug (21) inside the said cover (2).

8. A multimedia player and projector according to claim 1 wherein the said projector (100) has a rechargeable battery set (5) which is installed inside the said projector so the projector could operate without main power supply which could connect to the main power supply for recharging.

9. A multimedia player and projector, comprising with
A projector (100); a support (1) which is assembled on a side of the top of the projector (100) is for disposing the mobile device (10); a cover (2) which is assembled on a side of the top of projector (100), and the cover (2) could be opened and closed by lift up and down;
The said support (1) is assembled by a plate (11) which is connected to projector (100) by 2 axle blocks (3) and a latch (12) which is assembled on the rare of the plate (11) which could set the angle between the latch (12) and projector (100) from 0 to 90 degrees; a base (13) which is on the bottom of the plate (11) for sustaining the mobile device (10) which is disposed on said projector (100).

10. A multimedia player and projector according to claim 9 wherein the said projector (100) has 2 axle blocks (3) which are disposed on both end of sides of the top of said projector (100), and there are several slots (4) on the top of said projector (100) which is for fixing the position of the latch (12).

11. A multimedia player and projector according to claim 9 wherein the said projector (100) is one of following utility: projector, micro projector.

12. A multimedia player and projector according to claim 9 wherein the said plate has 2 boards (111) which are on the left and right side of the plate (11), and they could slide outward horizontally to adjust the width of the plate (11) for adapt the size of mobile device (10) which is disposed on the support (1). The rare side of said plate (11) has a gutter (112) for restoring the latch (12).

13. A multimedia player and projector according to claim 9 wherein the said latch (12) has bottom stick (121) on the bottom of the latch (12) which fix the slots (4) on the top of projector (100).

14. A multimedia player and projector according to claim 9 wherein the said mobile device (10) is one of following: smartphone, tablet PC, personal digital assistant, electronic book reader, digital camera and multimedia player.

15. A multimedia player and projector according to claim 9 wherein the said projector (100) has a rechargeable battery set (5) which is installed inside the said projector (100) so the projector could operate without main power supply which could connect to the main power supply for recharging.
